(19) United States
(12) Patent Application Publication
(10) Pub. No.: US 2025/0356862 A1
(43) Pub. Date: Nov. 20, 2025

(54) AUDIO ENCODING METHOD AND APPARATUS, DEVICE, AND STORAGE MEDIUM

(71) Applicant: DOUYIN VISION CO., LTD., Beijing (CN)

(72) Inventors: Jiawei JIANG, Beijing (CN); Dejun ZHANG, Beijing (CN); Ziqian WU, Beijing (CN); He WANG, Beijing (CN); Kunpeng LIN, Beijing (CN); Yijian XIAO, Beijing (CN); Piao DING, Beijing (CN); Shenyi SONG, Beijing (CN)

(21) Appl. No.: 18/871,454

(22) PCT Filed: Aug. 24, 2023
(86) PCT No.: PCT/CN2023/114573

§ 371 Date: Dec. 3, 2024

(30) Foreign Application Priority Data
Sep. 15, 2022 (CN) 202211124405.7

(51) Int. Cl. G10L 19/02

(52) U.S. Cl. CPC G10L 19/02

(57) ABSTRACT

An audio encoding method and apparatus, and a device and a storage medium. The audio encoding method comprises: acquiring an initial encoding rate and an overuse penalty code rate corresponding to the current audio frame; determining a main frame encoding proportion corresponding to the current audio frame; determining a main frame encoding rate of the current audio frame based on the initial encoding rate, the overuse penalty code rate, and the main frame encoding proportion; and obtaining main encoded audio data by encoding, based on the main frame encoding rate, the current audio frame.

### CROSS-REFERENCE TO RELATED APPLICATION(S)

This application claims priority to Chinese Patent Application No. 202211124405.7, filed with the China National Intellectual Property Administration on Sep. 15, 2022, the disclosure of which is incorporated herein by reference in its entirety.

### FIELD

The present disclosure relates to the technical field of audio encoding, and for example, relates to an audio encoding method and apparatus, a device, and a storage medium.

### BACKGROUND

The phenomenon of packet loss often exists in the process of transmitting audio data, and forward error correction (FEC) technology is typically used to overcome the packet loss. When the FEC technology is used for encoding, not only is information of a current frame (i.e., a main frame) encoded, but information of historical frames (i.e., redundant frames) is also encoded. However, there is a defect in code rate allocation when the FEC technology is used for encoding. When complex audio signals are encoded, the encoding code rate of the redundant frames often squeezes the main frame, resulting in a severe shortage of encoding rate for the main frame, and as a result, noise exists in encoded audio.

### SUMMARY

The present disclosure provides an audio encoding method and apparatus, a device, and a storage medium, which can reduce noise in encoded audio, and improve the audio encoding quality.

In a first aspect, the present disclosure provides an audio encoding method, including:
acquiring an initial encoding rate and an overuse penalty code rate corresponding to a current audio frame, where the overuse penalty code rate is determined based on an encoding bit overused by an encoded audio frame;
determining a main frame encoding proportion corresponding to the current audio frame;
determining a main frame encoding rate of the current audio frame based on the initial encoding rate, the overuse penalty code rate, and the main frame encoding proportion; and
obtaining main encoded audio data by encoding, based on the main frame encoding rate, the current audio frame.

In a second aspect, the present disclosure further provides an audio encoding apparatus, including:
an acquiring module, configured to acquire an initial encoding rate and an overuse penalty code rate corresponding to a current audio frame, where the overuse penalty code rate is determined based on an encoding bit overused by an encoded audio frame;
an encoding proportion determining module, configured to determine a main frame encoding proportion corresponding to the current audio frame;
a main frame encoding rate determining module, configured to determine a main frame encoding rate of the current audio frame based on the initial encoding rate, the overuse penalty code rate, and the main frame encoding proportion; and
an encoding module, configured to obtain main encoded audio data by encoding, based on the main frame encoding rate, the current audio frame.

In a third aspect, the present disclosure further provides an electronic device. The electronic device includes:
one or more processors; and
a storage, configured to store one or more programs.

The one or more programs, when executed by the one or more processors, cause the one or more processors to implement the above audio encoding method.

In a fourth aspect, the present disclosure further provides a storage medium including computer-executable instructions, where the computer-executable instructions, when executed by a computer processor, are used to perform the above audio encoding method.

In a fifth aspect, the present disclosure further provides a computer program product, including a computer program carried on a non-transitory computer-readable medium. The computer program includes program code used to perform the above audio encoding method.

### BRIEF DESCRIPTION OF THE DRAWINGS

FIG. 1 is a schematic flowchart of an audio encoding method according to an embodiment of the present disclosure;

FIG. 2 is a schematic diagram of a structure of an audio encoding apparatus according to an embodiment of the present disclosure; and

FIG. 3 is a schematic diagram of a structure of an electronic device according to an embodiment of the present disclosure.

### DETAILED DESCRIPTION OF EMBODIMENTS

Embodiments of the present disclosure will be described with reference to the accompanying drawings below. Although the accompanying drawings show some embodiments of the present disclosure, the present disclosure may be implemented in various forms, and these embodiments are provided for understanding the present disclosure. The accompanying drawings and the embodiments of the present disclosure are for exemplary purposes only.

A plurality of steps recorded in method implementations in the present disclosure may be performed in different orders and/or in parallel. In addition, additional steps may be included and/or the execution of the illustrated steps may be omitted in the method implementations. The scope of the present disclosure is not limited in this aspect.

The term “including” used herein and variations thereof are open-ended inclusions, namely “including”. The term “based on” is interpreted as “at least partially based on”. The term “an embodiment” means “at least one embodiment”; the term “another embodiment” means “at least one additional embodiment”; and the term “some embodiments” means “at least some embodiments”. Related definitions of other terms will be given in the description below.

Concepts such as “first” and “second” mentioned in the present disclosure are only for distinguishing different apparatuses, modules, or units, and are not intended to limit the order or relation of interdependence of functions performed by these apparatuses, modules, or units.

The modifiers “one” and “a plurality of” mentioned in the present disclosure are illustrative and not restrictive, and those skilled in the art should understand that unless otherwise explicitly specified in the context, the modifiers should be understood as “one or more”.

The names of messages or information exchanged between a plurality of apparatuses in the implementations of the present disclosure are used for illustrative purposes only, and are not used to limit the scope of these messages or information.

Before the use of the technical solutions disclosed in the embodiments of the present disclosure, a user shall be informed of the type, range of use, application scenarios, etc., of personal information involved in the present disclosure in an appropriate manner in accordance with the relevant laws and regulations, and the authorization of the user shall be obtained.

For example, in response to reception of an active request from the user, a prompt message is sent to the user to clearly inform the user that a requested operation will require access to and use of the personal information of the user. As such, the user can independently choose, based on the prompt message, whether to provide the personal information to software or hardware, such as an electronic device, an application, a server, or a storage medium, that performs the operations of the technical solutions of the present disclosure.

As an implementation, in response to the reception of the active request from the user, the method for sending the prompt message to the user may be, for example, a pop-up window, in which the prompt message may be presented in text. Further, the pop-up window may also carry a selection control for the user to choose whether to “agree” or “disagree” to provide the personal information to the electronic device.

The above notification and user authorization obtaining process is only illustrative, which does not limit the implementations of the present disclosure, and other methods that comply with relevant laws and regulations may also be applied to the implementations of the present disclosure.

Data (including the data itself, and data acquisition, or usage) involved in the technical solutions should comply with the requirements of corresponding laws and regulations, and relevant stipulations.

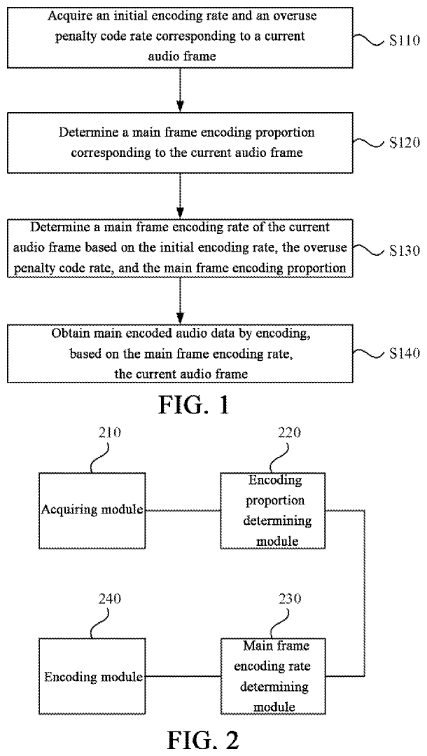

FIG. 1 is a schematic flowchart of an audio encoding method according to an embodiment of the present disclosure. This embodiment of the present disclosure is applicable to a case of determining an encoding rate of an audio frame. The method may be performed by an audio encoding apparatus. The apparatus may be implemented in the form of software and/or hardware, and is, for example, implemented by an electronic device. The electronic device may be a mobile terminal, a personal computer (PC) terminal, a server, or the like.

As shown in FIG. 1, the method includes:
S110: Acquire an initial encoding rate and an overuse penalty code rate corresponding to a current audio frame.

The initial encoding rate may be determined by an initial encoding bit and a frame rate of audio data. and the initial encoding bit may be a preset bit value. In this embodiment, the initial encoding rate may be calculated according to the following formula: initial encoding rate=initial encoding bit*frame rate. The overuse penalty code rate is determined based on an encoding bit overused by an encoded audio frame. That is. the overuse penalty code rate may be a code rate determined based on the bit overused by the encoded audio frame.

A method for determining an overuse penalty code rate corresponding to a current audio frame may include: determining total overuse bits of encoded audio frames; and determining the overuse penalty code rate based on the total overuse bits and a set overuse penalty coefficient.

The encoded audio frame may be an audio frame that has been encoded in current audio data. The total overuse bits may be the sum of bits overused by a plurality of encoded audio frames. The set overuse penalty coefficient may be any value between 1 and 10. In this embodiment, the set overuse penalty coefficient may be set to 2.

A method for determining total overuse bits of encoded audio frames may include: acquiring, for each encoded audio frame, a main frame encoding bit, an initial encoding bit, and a redundant frame encoding bit of a current encoded audio frame; determining an overuse bit of the current encoded audio frame based on the main frame encoding bit, the initial encoding bit, and the redundant frame encoding bit; and accumulating the overuse bits of the plurality of encoded audio frames to obtain the total overuse bits.

The main frame encoding bit may be a data amount after encoding a main audio frame based on a main frame encoding parameter. The initial encoding bit may be a preset encoding data amount for each audio frame. The redundant frame encoding bit may be a data amount after encoding a redundant audio frame based on a redundant encoding parameter. A redundant frame may be determined according to an FEC encoding algorithm, which is not limited herein.

In this embodiment, a method for determining an overuse bit of a current encoded audio frame based on a main frame encoding bit, an initial encoding bit, and a redundant frame encoding bit may include: first summing the main frame encoding bit and the redundant frame encoding bit, and then subtracting the initial encoding bit from a sum result to obtain the overuse bit of the current encoded audio frame. The formula may be expressed as: overuse bit=main frame encoding bit+redundant frame encoding bit−initial encoding bit. After obtaining the overuse bit of each encoded audio frame, the overuse bits of the plurality of encoded audio frames are accumulated to obtain total overuse bits corresponding to the current audio frame.

A method for determining an overuse penalty code rate based on total overuse bits and a set overuse penalty coefficient may include: multiplying the total overuse bits by the set overuse penalty coefficient to obtain the overuse penalty code rate. The formula may be expressed as: overuse penalty code rate=total overuse bits *overuse penalty coefficient.
S120: Determine a main frame encoding proportion corresponding to the current audio frame.

The main frame encoding proportion may be a proportion between a main frame encoding data amount and a total encoding data amount, i.e., a proportion between the main frame encoding bit and a total encoding bit, where the total encoding bit is the sum of the main frame encoding bit and the redundant frame encoding bit.

A method for determining a main frame encoding proportion corresponding to a current audio frame may include: determining a preset main frame encoding proportion as the final main frame encoding proportion.

Exemplarily, the preset main frame encoding proportion may be set to any value between 50% and 80%. The determining a preset main frame encoding proportion as the final main frame encoding proportion may mean that each audio frame uses the preset main frame encoding proportion, namely a fixed main frame encoding proportion. Exemplarily, the preset main frame encoding proportion is set to 70%, and therefore each audio frame uses the 70% main frame encoding proportion to determine a main frame encoding rate.

A method for determining a main frame encoding proportion corresponding to a current audio frame may include: determining total overuse bits of encoded audio frames, and determining a first adjustment amount based on the total overuse bits and a first set value; and adjusting the preset main frame encoding proportion based on the first adjustment amount to obtain a final main frame encoding proportion.

The total overuse bits may be the sum of bits overused by the plurality of encoded audio frames, and for a method for determining total overuse bits, reference may be made to the above embodiment, which is not repeated herein. The first set value may be set to any value between 1 and 1000, such as 100. A method for determining a first adjustment amount based on the total overuse bits and a first set value may include: dividing the total overuse bits by the first set value, and then dividing a division result by 100 to obtain the first adjustment amount. A calculation formula for the first adjustment amount may be expressed as: first adjustment amount=(total overuse bits/first set value) %. A method for adjusting the preset main frame encoding proportion based on the first adjustment amount may include: subtracting the first adjustment amount from the preset main frame encoding proportion to obtain the final main frame encoding proportion. In this embodiment, in response to the total number of overuse bit(s) being greater than 0, it indicates that the encoding data amount is overused, the calculated first adjustment amount is a positive number, and the subtracting the first adjustment amount from the preset main frame encoding proportion may be understood as reducing the main frame encoding proportion; in response to the total number of overuse bit(s) being less than 0, it indicates that the encoding data amount is underused, the calculated first adjustment amount is a negative number, and the subtracting the first adjustment amount from the preset main frame encoding proportion may be understood as increasing the main frame encoding proportion; and in response to the total number of overuse bit(s) being equal to 0, it indicates that the encoding data amount is not overused or underused, the calculated first adjustment amount is 0, and the subtracting the first adjustment amount from the preset main frame encoding proportion may be understood as keeping the main frame encoding proportion unchanged. In this embodiment, the main frame encoding proportion is adjusted based on the total overuse bits, and the main frame encoding proportion can be dynamically adjusted, thereby dynamically allocating the encoding rate.

A method for determining a main frame encoding proportion corresponding to a current audio frame may include: acquiring an overuse bit of a previous audio frame; determining a second adjustment amount based on the overuse bit of the previous audio frame and a second set value; and adjusting the preset main frame encoding proportion based on the second adjustment amount to obtain a final main frame encoding proportion.

The previous audio frame is an encoded audio frame and is the previous audio frame adjacent to the current audio frame. A method for acquiring an overuse bit of a previous audio frame may include: first acquiring a main frame encoding bit, an initial encoding bit, and a redundant frame encoding bit of the previous audio frame, then, summing the main frame encoding bit and the redundant frame encoding bit of the previous audio frame, and subtracting the initial encoding bit from a sum result, to obtain the overuse bit of the previous audio frame.

The second set value may be less than the first set value, and may be set to any value between 1 and 100, such as 50. A method for determining a second adjustment amount based on the overuse bit of the previous audio frame and a second set value may include: dividing the overuse bit of the previous audio frame by the second set value, and then dividing a division result by 100 to obtain the second adjustment amount. A calculation formula for the second adjustment amount may be expressed as: second adjustment amount=(overuse bit of previous audio frame/second set value) %. A method for adjusting the preset main frame encoding proportion based on the second adjustment amount may include: subtracting the second adjustment amount from the preset main frame encoding proportion to obtain the final main frame encoding proportion. In this embodiment, if the overuse bit of the previous audio frame is greater than 0, it indicates that the encoding data amount of the previous audio frame is overused, the calculated second adjustment amount is a positive number, and the subtracting the second adjustment amount from the preset main frame encoding proportion may be understood as reducing the main frame encoding proportion; if the overuse bit of the previous audio frame is less than 0, it indicates that the encoding data amount of the previous audio frame is underused, the calculated second adjustment amount is a negative number, and the subtracting the second adjustment amount from the preset main frame encoding proportion may be understood as increasing the main frame encoding proportion; and if the overuse bit of the previous audio frame is equal to 0, it indicates that the encoding data amount of the previous audio frame is not overused or underused, the calculated second adjustment amount is 0, and the subtracting the second adjustment amount from the preset main frame encoding proportion may be understood as keeping the main frame encoding proportion unchanged. In this embodiment, the main frame encoding proportion is adjusted based on the overuse bit of the previous audio frame, and the main frame encoding proportion can be dynamically adjusted, thereby dynamically allocating the encoding rate.
S130: Determine a main frame encoding rate of the current audio frame based on the initial encoding rate, the overuse penalty code rate, and the main frame encoding proportion.

The process of determining a main frame encoding rate of the current audio frame based on the initial encoding rate, the overuse penalty code rate, and the main frame encoding proportion may include: multiplying the initial encoding rate by the main frame encoding proportion to obtain a product result; and subtracting the overuse penalty code rate from the product result to obtain the main frame encoding code of the current audio frame.

In this embodiment, the formula for determining a main frame encoding rate of the current audio frame based on the initial encoding rate, the overuse penalty code rate, and the main frame encoding proportion may be expressed as: main frame encoding code=initial encoding rate*main frame encoding proportion-overuse penalty code rate. The main frame encoding rate of different audio frames can be dynamically determined.

The process of determining a main frame encoding rate of the current audio frame based on the initial encoding rate, the overuse penalty code rate, and the main frame encoding proportion may include: subtracting the overuse penalty code rate from the initial encoding rate to obtain a subtraction result; and multiplying the subtraction result by the main frame encoding proportion to obtain the main frame encoding rate of the current audio frame.

In this embodiment, the formula for determining a main frame encoding rate of the current audio frame based on the initial encoding rate, the overuse penalty code rate, and the main frame encoding proportion may be expressed as: main frame encoding code=(initial encoding rate-overuse penalty code rate)*main frame encoding proportion. The main frame encoding rate of different audio frames can be dynamically determined.
S140: Obtain main encoded audio data by encoding, based on the main frame encoding rate, the current audio frame.

In this embodiment, the process of encoding the current audio frame based on the main frame encoding rate may include: determining a main frame encoding parameter based on the main frame encoding rate, and encoding the current audio frame based on the main frame encoding parameter.

The corresponding main frame encoding parameter is obtained through table lookup based on the main frame encoding rate. The process of encoding the current audio frame based on the main frame encoding parameter may include: dividing an excitation signal by the main frame encoding parameter to obtain a main frame signal-to-noise ratio, and encoding the current audio frame based on the main frame signal-to-noise ratio.

After the encoding the current audio frame based on the main frame encoding rate, the method further includes: determining a redundant frame encoding parameter based on the main frame encoding rate and a set redundancy gain; and encoding a redundant audio frame corresponding to the current audio frame based on the redundant frame encoding parameter to obtain redundant encoded audio data.

The set redundancy gain may reflect a proportion between a main frame and a redundant frame, such as 6:4 or 7:3, and may be set by the user according to encoding requirements.

The process of determining a redundant frame encoding parameter based on the main frame encoding rate and a set redundancy gain may include: first acquiring a main frame encoding parameter based on the main frame encoding rate, and then accumulating the main frame encoding parameter and the set redundancy gain to obtain the redundant frame encoding parameter. The calculation formula may be expressed as: redundant frame encoding parameter=main frame encoding parameter+set redundancy gain. The process of encoding a redundant audio frame corresponding to the current audio frame based on the redundant frame encoding parameter may include: dividing an excitation signal by the redundant frame encoding parameter to obtain a redundant frame signal-to-noise ratio, and encoding the redundant frame corresponding to the current audio frame based on the redundant frame signal-to-noise ratio.

According to the technical solution of this embodiment of the present disclosure, the initial encoding rate, the overuse penalty code rate, and the main frame encoding proportion corresponding to the current audio are determined: the main frame encoding rate of the current audio frame is determined based on the initial encoding rate, the overuse penalty code rate, and the main frame encoding proportion; and the current audio frame is encoded based on the main frame encoding rate to obtain the main encoded audio data. According to the audio encoding method provided in this embodiment of the present disclosure, the main frame encoding rate of the current audio frame is determined based on the initial encoding rate, the overuse penalty code rate, and the main frame encoding proportion, such that the current audio frame is encoded based on the main frame encoding code. The encoding rate can be dynamically allocated to each audio frame, such that there are smaller fluctuations in encoding rates between different audio frames, thereby reducing noise in encoded audio, and then improving the audio encoding quality.

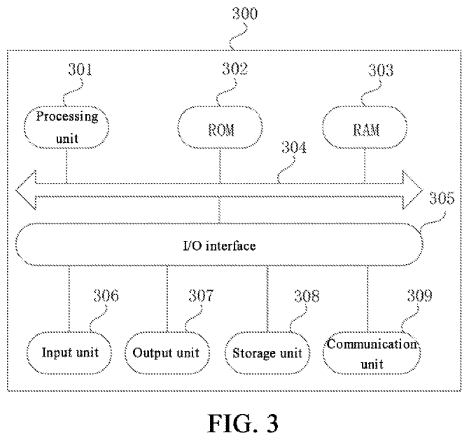

FIG. 2 is a schematic diagram of a structure of an audio encoding apparatus according to an embodiment of the present disclosure. As shown in FIG. 2, the apparatus includes:
an acquiring module 210, configured to acquire an initial encoding rate and an overuse penalty code rate corresponding to a current audio frame, where the overuse penalty code rate is determined based on an encoding bit overused by an encoded audio frame; an encoding proportion determining module 220, configured to determine a main frame encoding proportion; a main frame encoding rate determining module 230, configured to determine a main frame encoding rate of the current audio frame based on the initial encoding rate, the overuse penalty code rate, and the main frame encoding proportion; and an encoding module 240, configured to encode the current audio frame based on the main frame encoding rate to obtain main encoded audio data.

The encoding proportion determining module 220 is configured to:
determine a preset main frame encoding proportion as a final main frame encoding proportion.

The encoding proportion determining module 220 is configured to:
determine a first adjustment amount based on the total overuse bits and a first set value; and adjust the preset main frame encoding proportion based on the first adjustment amount to obtain a final main frame encoding proportion.

The encoding proportion determining module 220 is configured to:
acquire an overuse bit of a previous audio frame; determine a second adjustment amount based on the overuse bit of the previous audio frame and a second set value; and adjust the preset main frame encoding proportion based on the second adjustment amount to obtain a final main frame encoding proportion.

The main frame encoding rate determining module 230 is configured to:
multiply the initial encoding rate by the main frame encoding proportion to obtain a product result; and subtract the overuse penalty code rate from the product result to obtain a main frame encoding code of the current audio frame.

The main frame encoding rate determining module 230 is configured to:
subtract the overuse penalty code rate from the initial encoding rate to obtain a subtraction result; and multiply the subtraction result by the main frame encoding proportion to obtain a main frame encoding rate of the current audio frame.

A redundant frame encoding module is further included, and configured to:
determine a redundant frame encoding parameter based on the main frame encoding rate and a set redundancy gain; and encode a redundant audio frame corresponding to the current audio frame based on the redundant frame encoding parameter to obtain redundant encoded audio data.

The audio encoding apparatus provided in this embodiment of the present disclosure may perform the audio encoding method provided in any embodiment of the present disclosure, and has the corresponding functional modules and effects for performing the method.

The plurality of units and modules included in the above apparatus are only divided according to functional logics, but are not limited to the above division, as long as the corresponding functions can be achieved; and in addition, the names of the plurality of functional units are only for the convenience of distinguishing each other, and are not intended to limit the scope of protection of the embodiments of the present disclosure.

FIG. 3 is a schematic diagram of a structure of an electronic device according to an embodiment of the present disclosure. Referring to FIG. 3 as below. FIG. 3 illustrates a schematic diagram of a structure of an electronic device (e.g., a terminal device or a server in FIG. 3) 300 suitable for implementing an embodiment of the present disclosure. The terminal device in this embodiment of the present disclosure may include mobile terminals such as a mobile phone, a notebook computer, a digital radio receiver, a personal digital assistant (PDA), a portable Android device (PAD), a portable media player (PMP), and a vehicle-mounted terminal (e.g., a vehicle navigation terminal), and fixed terminals such as a digital television (TV) and a desk computer. The terminal device 300 shown in FIG. 3 is merely an example, which should not impose any limitations on functions and scope of use of this embodiment of the present disclosure.

As shown in FIG. 3, the electronic device 300 may include a processing unit (e.g., a central processing unit and a graphics processing unit) 301, which may perform various appropriate actions and processing according to a program stored on a read-only memory (ROM) 302 or a program loaded from a storage 308 into a random access memory (RAM) 303. The RAM 303 further stores various programs and data required for the operation of the electronic device 300. The processing unit 301, the ROM 302, and the RAM 303 are connected to one another through a bus 304. An input/output (I/O) interface 305 is also connected to the bus 304.

Typically, the following apparatuses may be connected to the I/O interface 305: an input unit 306, including, for example, a touchscreen, a touchpad, a keyboard, a mouse, a camera, a microphone, an accelerometer, and a gyroscope; an output unit 307, including, for example, a liquid crystal display (LCD), a speaker, and a vibrator; the storage 308, including, for example, a magnetic tape and a hard drive; and a communication unit 309. The communication unit 309 may allow the electronic device 300 to perform wireless or wired communication with other devices to exchange data. Although FIG. 3 illustrates the electronic device 300 with various apparatuses, it is not necessary to implement or have all the shown apparatuses. It may be an alternative to implement or have more or fewer apparatuses.

According to this embodiment of the present disclosure, the above process described with reference to the flowchart may be implemented as a computer software program. For example, an embodiment of the present disclosure includes a computer program product, which includes a computer program carried on a non-transitory computer-readable medium, where the computer program includes program code used to perform the method shown in the flowchart. In this embodiment, the computer program may be downloaded and installed from the network through the communication unit 309, installed from the storage 308, or installed from the ROM 302. The computer program, when executed by the processing unit 301, performs the above functions limited in the method in this embodiment of the present disclosure.

The names of messages or information exchanged between a plurality of apparatuses in the implementations of the present disclosure are used for illustrative purposes only, and are not used to limit the scope of these messages or information.

The electronic device provided in this embodiment of the present disclosure and the audio encoding method provided in the above embodiment belong to the same concept, and for technical details not described in detail in this embodiment, reference may be made to the above embodiment. This embodiment and the above embodiment have the same effects.

An embodiment of the present disclosure provides a computer storage medium having a computer program stored thereon, where the program, when executed by a processor, implements the audio encoding method provided in the above embodiment.

The computer-readable medium in the present disclosure may be a computer-readable signal medium, or a computer-readable storage medium, or any combination of the above. For example, the computer-readable storage medium may include: electrical, magnetic, optical, electromagnetic, infrared, or semiconductor systems, apparatuses, or devices, or any combination of the above. Examples of the computer-readable storage medium may include: an electrical connection with one or more wires, a portable computer disk, a hard drive, a RAM, a ROM, an erasable programmable read-only memory (EPROM or a flash memory), an optical fiber, a portable compact disc read-only memory (CD-ROM), an optical storage device, a magnetic storage device, or any proper combination of the above. In the present disclosure, the computer-readable storage medium may be any tangible medium including or storing a program, and the program may be for use by or for use in combination with an instruction execution system, apparatus, or device. However, in the present disclosure, the computer-readable signal medium may include a data signal propagated in a baseband or as a part of a carrier, where the data signal carries computer-readable program code. The propagated data signal may take various forms, including an electromagnetic signal, an optical signal, or any suitable combination of the above. The computer-readable signal medium may also be any computer-readable medium other than the computer-readable storage medium. The computer-readable signal medium may send, propagate, or transmit a program for use by or for use in combination with the instruction execution system, apparatus, or device. The program code included in the computer-readable medium may be transmitted by any suitable medium including: a wire, an optical cable, radio frequency (RF), etc., or any suitable combination of the above.

In some implementations, a client and a server may communicate using any currently known or future-developed network protocols such as a hypertext transfer protocol (HTTP), and may also be interconnected with digital data communication in any form or medium (e.g., a communication network). Examples of the communication network include a local area network (LAN), a wide area network (WAN), an internetwork (e.g.,

the Internet), a peer-to-peer network (e.g., an ad hoc peer-to-peer network), and any currently known or future-developed network.

The above computer-readable medium may be included in the above electronic device; or may also separately exist without being assembled in the electronic device.

The above computer-readable medium carries one or more programs. The one or more programs, when executed by the electronic device, cause the electronic device to: acquire an initial encoding rate and an overuse penalty code rate corresponding to a current audio frame; determine a main frame encoding proportion corresponding to the current audio frame; determine a main frame encoding rate of the current audio frame based on the initial encoding rate, the overuse penalty code rate, and the main frame encoding proportion; and obtain main encoded audio data based on the main frame encoding rate and the current audio frame.

Computer program code for performing the operations in the present disclosure may be written in one or more programming languages or a combination thereof, where the programming languages include an object-oriented programming language, such as Java. Smalltalk, and C++, and further include conventional procedural programming languages, such as “C” language or similar programming languages. The program code may be executed entirely on a user computer, partly on the user computer, as a stand-alone software package, partly on the user computer and partly on a remote computer, or entirely on the remote computer or the server. In the case of involving the remote computer, the remote computer may be connected to the user computer through any type of network, including a LAN or WAN, or may be connected to an external computer (e.g., utilizing an Internet service provider for Internet connectivity).

The flowcharts and the block diagrams in the accompanying drawings illustrate the possibly implemented system architecture, functions, and operations of the system, the method, and the computer program product according to the various embodiments of the present disclosure. In this regard, each block in the flowcharts or the block diagrams may represent a module, a program segment, or a part of code, and the module, the program segment, or the part of code includes one or more executable instructions for implementing specified logic functions. It should also be noted that in some alternative implementations, the functions marked in the blocks may also occur in an order different from that marked in the accompanying drawings. For example, two blocks shown in succession may actually be performed substantially in parallel, or may sometimes be performed in a reverse order, depending on the functions involved. It should also be noted that each block in the block diagrams and/or the flowcharts, and a combination of the blocks in the block diagrams and/or the flowcharts may be implemented by using a dedicated hardware-based system that performs specified functions or operations, or may be implemented by using a combination of dedicated hardware and computer instructions.

The related units described in the embodiments of the present disclosure may be implemented by software or hardware. The name of the unit does not limit the unit itself in a certain case. For example, a first acquiring unit may also be described as “a unit for acquiring at least two Internet protocol addresses”.

Herein, the functions described above may be at least partially executed by one or more hardware logic components. For example, exemplary hardware logic components that can be used include, but are not limited to: a field programmable gate array (FPGA), an application specific integrated circuit (ASIC), application specific standard parts (ASSPs), a system on chip (SOC), a complex programmable logic device (CPLD), etc.

In the context of the present disclosure, a machine-readable medium may be a tangible medium that may include or store a program for use by or for use in combination with the instruction execution system, apparatus, or device. The machine-readable medium may be a machine-readable signal medium or a machine-readable storage medium. The machine-readable medium may include electronic, magnetic, optical, electromagnetic, infrared, or semiconductor systems, apparatuses, or devices, or any suitable combination of the above content. Examples of the machine-readable storage medium may include: an electrical connection based on one or more wires, a portable computer disk, a hard drive, a RAM, a ROM, an EPROM or a flash memory, an optical fiber, a CD-ROM, an optical storage device, a magnetic storage device, or any suitable combination of the above content.

According to one or more embodiments of the present disclosure, an audio encoding method is provided and includes:
acquiring an initial encoding rate and an overuse penalty code rate corresponding to a current audio frame, where the overuse penalty code rate is determined based on an encoding bit overused by an encoded audio frame;
determining a main frame encoding proportion corresponding to the current audio frame;
determining a main frame encoding rate of the current audio frame based on the initial encoding rate, the overuse penalty code rate, and the main frame encoding proportion; and
encoding the current audio frame based on the main frame encoding rate to obtain main encoded audio data.

The determining a main frame encoding proportion corresponding to the current audio frame includes:
determining a preset main frame encoding proportion as a final main frame encoding proportion.

The determining a main frame encoding proportion corresponding to the current audio frame includes:
determining a first adjustment amount based on the total overuse bits and a first set value; and
adjusting the preset main frame encoding proportion based on the first adjustment amount to obtain a final main frame encoding proportion.

The determining a main frame encoding proportion corresponding to the current audio frame includes:
acquiring an overuse bit of a previous audio frame;
determining a second adjustment amount based on the overuse bit of the previous audio frame and a second set value; and
adjusting the preset main frame encoding proportion based on the second adjustment amount to obtain a final main frame encoding proportion.

The determining a main frame encoding rate of the current audio frame based on the initial encoding rate, the overuse penalty code rate, and the main frame encoding proportion includes:
multiplying the initial encoding rate by the main frame encoding proportion to obtain a product result; and
subtracting the overuse penalty code rate from the product result to obtain a main frame encoding code of the current audio frame.

The determining a main frame encoding rate of the current audio frame based on the initial encoding rate, the overuse penalty code rate, and the main frame encoding proportion includes:
subtracting the overuse penalty code rate from the initial encoding rate to obtain a subtraction result; and
multiplying the subtraction result by the main frame encoding proportion to obtain a main frame encoding rate of the current audio frame.

After the encoding the current audio frame based on the main frame encoding rate, the method further includes:
determining a redundant frame encoding parameter based on the main frame encoding rate and a set redundancy gain; and
encoding a redundant audio frame corresponding to the current audio frame based on the redundant frame encoding parameter to obtain redundant encoded audio data.

Further, although the plurality of operations are described in a particular order, it should not be understood as requiring these operations to be performed in the shown particular order or in a sequential order. In certain environments, multitasking and parallel processing may be advantageous. Similarly, although several implementation details are included in the above discussion, these implementation details should not be interpreted as limitations on the scope of the present disclosure. Some features described in the context of separate embodiments may also be implemented in combination in a single embodiment. In contrast, various features described in the context of a single embodiment may also be implemented in a plurality of embodiments separately or in any suitable subcombination.

1. An audio encoding method, comprising:
acquiring an initial encoding rate and an overuse penalty code rate corresponding to a current audio frame, wherein the overuse penalty code rate is determined based on an encoding bit overused by an encoded audio frame;
determining a main frame encoding proportion corresponding to the current audio frame;
determining a main frame encoding rate of the current audio frame based on the initial encoding rate, the overuse penalty code rate, and the main frame encoding proportion; and
obtaining main encoded audio data by encoding, based on the main frame encoding rate, the current audio frame.

2. The method of claim 1, wherein determining the main frame encoding proportion corresponding to the current audio frame comprises:
determining a preset main frame encoding proportion as a final main frame encoding proportion.

3. The method of claim 2, wherein determining the main frame encoding proportion corresponding to the current audio frame comprises:
determining total overuse bits of encoded audio frames;
determining a first adjustment amount based on the total overuse bits and a first set value; and
obtaining a final main frame encoding proportion by adjusting, based on the first adjustment amount, the preset main frame encoding proportion.

4. The method of claim 2, wherein the determining a main frame encoding proportion corresponding to the current audio frame comprises:
acquiring an overuse bit of a previous audio frame;
determining a second adjustment amount based on the overuse bit of the previous audio frame and a second set value; and
obtaining a final main frame encoding proportion by adjusting, based on the second adjustment amount, the preset main frame encoding proportion.

5. The method of claim 1, wherein determining the main frame encoding rate of the current audio frame based on the initial encoding rate, the overuse penalty code rate, and the main frame encoding proportion comprises:
obtaining a product result by multiplying the initial encoding rate by the main frame encoding proportion; and
obtaining a main frame encoding code of the current audio frame by subtracting the overuse penalty code rate from the product result.

6. The method of claim 1, wherein determining the main frame encoding rate of the current audio frame based on the initial encoding rate, the overuse penalty code rate, and the main frame encoding proportion comprises:
obtaining a subtraction result by subtracting the overuse penalty code rate from the initial encoding rate; and
obtaining a main frame encoding rate of the current audio frame by multiplying the subtraction result by the main frame encoding proportion.

7. The method of claim 1, wherein the method further comprises: after encoding, based on the main frame encoding rate, the current audio frame;
determining a redundant frame encoding parameter based on the main frame encoding rate and a set redundancy gain; and
obtaining redundant encoded audio data by encoding, based on the redundant frame encoding parameter, a redundant audio frame corresponding to the current audio frame.

8. (canceled)

9. An electronic device, comprising:
at least one processor; and
a storage, configured to store at least one program,
wherein the at least one program, when executed by the at least one processor, causes the at least one processor to:
acquire an initial encoding rate and an overuse penalty code rate corresponding to a current audio frame, wherein the overuse penalty code rate is determined based on an encoding bit overused by an encoded audio frame;
determine a main frame encoding proportion corresponding to the current audio frame;
determine a main frame encoding rate of the current audio frame based on the initial encoding rate, the overuse penalty code rate, and the main frame encoding proportion; and
obtain main encoded audio data by encoding, based on the main frame encoding rate, the current audio frame.

10. A non-transitory storage medium comprising computer-executable instructions, wherein the computer-executable instructions, when executed by a computer processor, causes the computer processor to:
acquire an initial encoding rate and an overuse penalty code rate corresponding to a current audio frame, wherein the overuse penalty code rate is determined based on an encoding bit overused by an encoded audio frame;
determine a main frame encoding proportion corresponding to the current audio frame;
determine a main frame encoding rate of the current audio frame based on the initial encoding rate, the overuse penalty code rate, and the main frame encoding proportion; and
obtain main encoded audio data by encoding, based on the main frame encoding rate, the current audio frame.

11. (canceled)

12. The electronic device of claim 9, wherein the at least one program that causes the at least one processor to determine the main frame encoding proportion corresponding to the current audio frame comprises instructions to:
determine a preset main frame encoding proportion as a final main frame encoding proportion.

13. The electronic device of claim 12, wherein the at least one program that causes the at least one processor to determine the main frame encoding proportion corresponding to the current audio frame comprises instructions to:
determine total overuse bits of encoded audio frames;
determine a first adjustment amount based on the total overuse bits and a first set value; and
obtain a final main frame encoding proportion by adjusting, based on the first adjustment amount, the preset main frame encoding proportion.

14. The electronic device of claim 12, wherein the at least one program that causes the at least one processor to determine a main frame encoding proportion corresponding to the current audio frame comprises instructions to:
acquire an overuse bit of a previous audio frame;
determine a second adjustment amount based on the overuse bit of the previous audio frame and a second set value; and
obtain a final main frame encoding proportion by adjusting, based on the second adjustment amount, the preset main frame encoding proportion.

15. The electronic device of claim 9, wherein the at least one program that causes the at least one processor to determine the main frame encoding rate of the current audio frame based on the initial encoding rate, the overuse penalty code rate, and the main frame encoding proportion comprises instructions to:
obtain a product result by multiplying the initial encoding rate by the main frame encoding proportion; and
obtain a main frame encoding code of the current audio frame by subtracting the overuse penalty code rate from the product result.

16. The electronic device of claim 9, wherein the at least one program that causes the at least one processor to determine the main frame encoding rate of the current audio frame based on the initial encoding rate, the overuse penalty code rate, and the main frame encoding proportion comprises instructions to:
obtain a subtraction result by subtracting the overuse penalty code rate from the initial encoding rate; and
obtain a main frame encoding rate of the current audio frame by multiplying the subtraction result by the main frame encoding proportion.

17. The electronic device of claim 9, wherein the at least one processor is further caused: after encoding, based on the main frame encoding rate, the current audio frame:
determine a redundant frame encoding parameter based on the main frame encoding rate and a set redundancy gain; and
obtain redundant encoded audio data by encoding, based on the redundant frame encoding parameter, a redundant audio frame corresponding to the current audio frame.

18. The non-transitory storage medium of claim 10, wherein the computer-executable instructions that cause the computer processor to determine the main frame encoding proportion corresponding to the current audio frame comprises instructions to:
determine a preset main frame encoding proportion as a final main frame encoding proportion.

19. The non-transitory storage medium of claim 18, wherein the computer-executable instructions that cause the computer processor to determine the main frame encoding proportion corresponding to the current audio frame comprises instructions to:
determine total overuse bits of encoded audio frames;
determine a first adjustment amount based on the total overuse bits and a first set value; and
obtain a final main frame encoding proportion by adjusting, based on the first adjustment amount, the preset main frame encoding proportion.

20. The non-transitory storage medium of claim 10, wherein the computer-executable instructions that cause the computer processor to determine the main frame encoding rate of the current audio frame based on the initial encoding rate, the overuse penalty code rate, and the main frame encoding proportion comprises instructions to:
obtain a product result by multiplying the initial encoding rate by the main frame encoding proportion; and
obtain a main frame encoding code of the current audio frame by subtracting the overuse penalty code rate from the product result.

21. The non-transitory storage medium of claim 10, wherein the computer-executable instructions that cause the computer processor to determine the main frame encoding rate of the current audio frame based on the initial encoding rate, the overuse penalty code rate, and the main frame encoding proportion comprises instructions to:
obtain a subtraction result by subtracting the overuse penalty code rate from the initial encoding rate; and
obtain a main frame encoding rate of the current audio frame by multiplying the subtraction result by the main frame encoding proportion.

22. The non-transitory storage medium of claim 10, wherein the computer processor is further caused: after encoding, based on the main frame encoding rate, the current audio frame:
determine a redundant frame encoding parameter based on the main frame encoding rate and a set redundancy gain; and
obtain redundant encoded audio data by encoding, based on the redundant frame encoding parameter, a redundant audio frame corresponding to the current audio frame.
